(19) United States
(12) Patent Application Publication
(10) Pub. No.: US 2026/0136402 A1
(43) Pub. Date: May 14, 2026

(54) CONFIGURATION AND ADAPTATION OF ADDITIONAL PHYSICAL RANDOM ACCESS CHANNEL RESOURCES

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/946,831

(22) Filed: Nov. 13, 2024

(51) Int. Cl. H04W 74/0833

(52) U.S. Cl. CPC H04W 74/0833

(57) ABSTRACT

Methods, systems, and devices for wireless communications are described. A user equipment (UE) may receive information identifying a set of physical random access channel (PRACH) configurations, each PRACH configuration in the set of PRACH configurations identifying additional PRACH resources available for PRACH transmissions. The UE may receive an activation signal that activates one or more PRACH configurations in the set of PRACH configurations. The UE may perform one or more PRACH transmissions using the additional PRACH resources corresponding to the one or more PRACH configurations that are activated.

### FIELD OF TECHNOLOGY

The present disclosure relates to wireless communications, including configuration and adaptation of additional physical random access channel resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving information identifying a set of physical random access channel (PRACH) configurations, each PRACH configuration in the set of PRACH configurations identifying additional PRACH resources available for PRACH transmissions, receiving an activation signal that activates one or more PRACH configurations in the set of PRACH configurations, and performing one or more PRACH transmissions using the additional PRACH resources corresponding to the one or more PRACH configurations that are activated.

A UE for wireless communications is described. The UE may include one or more memories storing processor-executable code, and one or more processors coupled with the one or more memories. The one or more processors may individually or collectively be operable to execute the code to cause the UE to receive information identifying a set of PRACH configurations, each PRACH configuration in the set of PRACH configurations identifying additional PRACH resources available for PRACH transmissions, receive an activation signal that activates one or more PRACH configurations in the set of PRACH configurations, and perform one or more PRACH transmissions using the additional PRACH resources corresponding to the one or more PRACH configurations that are activated.

Another UE for wireless communications is described. The UE may include means for receiving information identifying a set of PRACH configurations, each PRACH configuration in the set of PRACH configurations identifying additional PRACH resources available for PRACH transmissions, means for receiving an activation signal that activates one or more PRACH configurations in the set of PRACH configurations, and means for performing one or more PRACH transmissions using the additional PRACH resources corresponding to the one or more PRACH configurations that are activated.

A non-transitory computer-readable medium storing code for wireless communications is described. The code may include instructions executable by one or more processors to receive information identifying a set of PRACH configurations, each PRACH configuration in the set of PRACH configurations identifying additional PRACH resources available for PRACH transmissions, receive an activation signal that activates one or more PRACH configurations in the set of PRACH configurations, and perform one or more PRACH transmissions using the additional PRACH resources corresponding to the one or more PRACH configurations that are activated.

In some examples of the method, user equipment (UEs), and non-transitory computer-readable medium described herein, PRACH configurations include a common configuration among the set of PRACH configurations.

In some examples of the method, user equipment (UEs), and non-transitory computer-readable medium described herein, the common configuration corresponds to a common scaling factor being applied to one or more parameters of each PRACH configuration in the set of PRACH configurations.

In some examples of the method, user equipment (UEs), and non-transitory computer-readable medium described herein, the different configurations corresponds to different scaling factors being applied to one or more parameters of each PRACH configuration in the set of PRACH configurations.

In some examples of the method, user equipment (UEs), and non-transitory computer-readable medium described herein, PRACH configurations include different configurations among the set of PRACH configurations.

In some examples of the method, user equipment (UEs), and non-transitory computer-readable medium described herein, PRACH configurations in the set of PRACH configurations include a same feature combination configuration as a legacy PRACH configuration that may be different from the set of PRACH configurations.

In some examples of the method, user equipment (UEs), and non-transitory computer-readable medium described herein, PRACH configurations in the set of PRACH configurations include a different feature combination configuration as a legacy PRACH configuration that may be different from the set of PRACH configurations.

In some examples of the method, user equipment (UEs), and non-transitory computer-readable medium described herein, the activation signal activates each PRACH configuration in the set of PRACH configurations.

In some examples of the method, user equipment (UEs), and non-transitory computer-readable medium described herein, the activation signal includes an indication of which PRACH configurations in the set of PRACH configurations may be activated.

In some examples of the method, user equipment (UEs), and non-transitory computer-readable medium described herein, the set of PRACH configurations includes one or more subsets of PRACH configurations and the activation signal identifies which subsets of PRACH configurations in the set of PRACH configurations may be activated.

In some examples of the method, user equipment (UEs), and non-transitory computer-readable medium described herein, different subsets of the one or more subsets of PRACH configurations correspond to an operating mode of the UE.

In some examples of the method, user equipment (UEs), and non-transitory computer-readable medium described herein, the activation signal includes an indication of a feature combination activation state for the one or more PRACH configurations.

In some examples of the method, user equipment (UEs), and non-transitory computer-readable medium described herein, the feature combination activation state corresponds to all feature combinations, a subset of feature combinations, or individual feature combinations in the set of PRACH configurations.

In some examples of the method, user equipment (UEs), and non-transitory computer-readable medium described herein, the information identifying the set of PRACH configurations may be received in the activation signal.

In some examples of the method, user equipment (UEs), and non-transitory computer-readable medium described herein, the information identifying the set of PRACH configurations may be received in a signal that may be different from the activation signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports configuration and adaptation of additional physical random access channel (PRACH) resources in accordance with one or more aspects of the present disclosure.

FIG. 2 shows an example of a wireless communications system that supports configuration and adaptation of additional PRACH resources in accordance with one or more aspects of the present disclosure.

FIG. 3 shows an example of a PRACH scheme that supports configuration and adaptation of additional PRACH resources in accordance with one or more aspects of the present disclosure.

FIG. 4 shows an example of a method that supports configuration and adaptation of additional PRACH resources in accordance with one or more aspects of the present disclosure.

FIGS. 5 and 6 show block diagrams of devices that support configuration and adaptation of additional PRACH resources in accordance with one or more aspects of the present disclosure.

FIG. 7 shows a diagram of a system including a device that supports configuration and adaptation of additional PRACH resources in accordance with one or more aspects of the present disclosure.

FIG. 8 shows a flowchart illustrating methods that support configuration and adaptation of additional PRACH resources in accordance with one or more aspects of the present disclosure.

### DETAILED DESCRIPTION

Wireless networks may configure or otherwise allocate physical random access channel (PRACH) occasions (ROs) for user equipment (UE). The ROs may include PRACH configurations identifying PRACH resources being signaled to or otherwise identified by the UE to use for PRACH transmissions. The ROs may include legacy ROs configured for legacy UE as well as one or more sets of additional ROs configured for advanced UE. Moreover, the additional ROs may be configured for a variety of functions, such as initial access, handover, beam failure recovery (BFR), and many other triggering events. Within one PRACH configuration, different sets of ROs may be defined for specific features and, across different PRACH configurations, there may be additional PRACH resources.

Accordingly, aspects of the techniques described herein provide for the configuration of additional PRACH configurations for multiple configurations. For example, the UE may receive or otherwise obtain information identifying a set of PRACH configurations. Each PRACH configuration in the set may identify additional PRACH resources available for PRACH transmissions. The UE may receive or otherwise obtain an activation signal that activates one or more of the PRACH configurations in the set of PRACH configurations. The UE may perform one or more PRACH transmissions using the additional PRACH resources corresponding to the one or more PRACH configurations that are activated.

Aspects of the disclosure are initially described in the context of wireless communications systems. Aspects of the disclosure are further illustrated by and described with reference to apparatus diagrams, system diagrams, and flowcharts that relate to configuration and adaptation of additional PRACH resources.

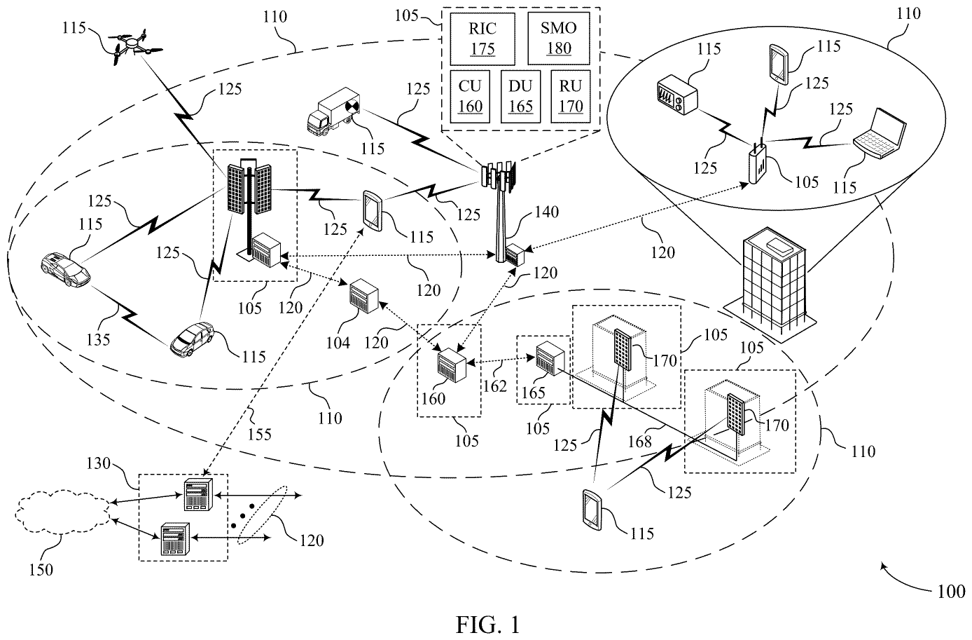

FIG. 1 shows an example of a wireless communications system 100 that supports configuration and adaptation of additional PRACH resources in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support configuration and adaptation of additional PRACH resources as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive information identifying a set of PRACH configurations, each PRACH configuration in the set of PRACH configurations identifying additional PRACH resources available for PRACH transmissions. The UE 115 may receive an activation signal that activates one or more PRACH configurations in the set of PRACH configurations. The UE 115 may perform one or more PRACH transmissions using the additional PRACH resources corresponding to the one or more PRACH configurations that are activated.

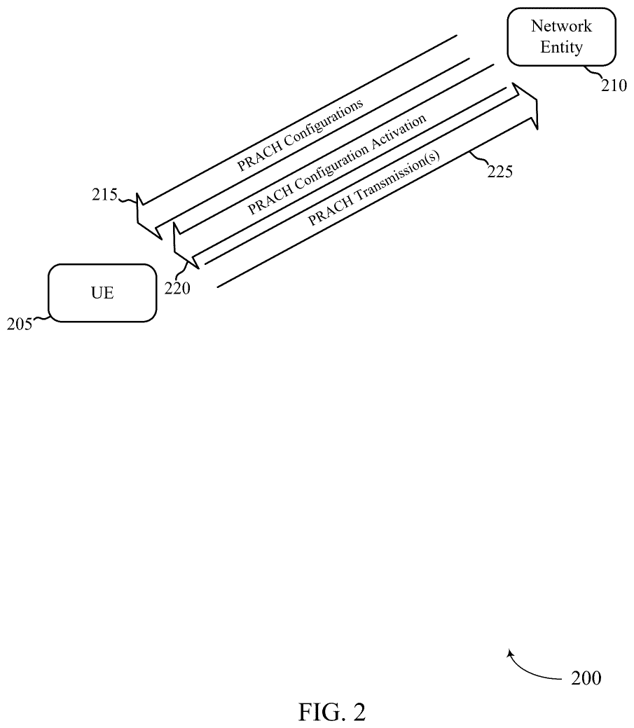

FIG. 2 shows an example of a wireless communications system 200 that supports configuration and adaptation of additional PRACH resources in accordance with one or more aspects of the present disclosure. The wireless communications system 200 may implement aspects of or be implemented by aspects of the wireless communications system 100. The wireless communications system 200 may include a UE 205 and a network entity 210, which may be examples of the corresponding devices described herein.

Wireless networks may support the dynamic adaptation of PRACH, such as in the time domain, as part of network energy saving (NES) protocols. For adaptation of PRACH in time-domain, this may include UE(s) identifying or otherwise determining the additional PRACH resources in the time-domain. Different approaches may be applied for this identifying or determining. A first approach may be based on the same PRACH configuration index being used for additional and legacy PRACH resources. The UE may select one or more additional mechanism(s). One mechanism may include up to N1 additional value(s) of (x, y) and, optionally, a value of N1(>=1). Another mechanism may include up to N2 additional value(s) of y and, optionally, a value of N2 (>=1). Another mechanism may include muting or masking RO(s). Another mechanism may include one or more of: up to N4_1 additional timing offset(s) at the frame-level; up to N4_2 additional timing offset(s) at the slot-level; and, optionally, value(s) of N4_1(>=1) and N4_2(>=1). Another mechanism may include there being no additional mechanism selected. In this context, x and y may refer to the parameters from the random-access configuration tables.

Another approach may include, for different PRACH configuration index for additional and legacy PRACH resources, the UE selecting one or more additional mechanism(s). One mechanism may include up to N1 additional value(s) of (x, y) and, optionally, a value of N1(>=1). Another mechanism may include up to N2 additional value(s) of y and, optionally, a value of N2(>=1). Another mechanism may include muting or masking RO(s). Another mechanism may include one or more of: up to N4_1 additional timing offset(s) at the frame-level; up to N4_2 additional timing offset(s) at the slot-level; and, optionally, values of N4_1(>=1) and N4_2(>=1). Another mechanism may include no additional mechanism being selected. Again, in this context x and y may refer to the parameters from the random-access configuration tables.

Accordingly, the UE may be configured with multiple PRACH configurations where each PRACH configuration identifies PRACH resources available for PRACH transmission. Each PRACH configuration may also include various parameters associated with the PRACH resources (e.g., periodicity). In some aspects, the PRACH configurations may include a legacy PRACH configuration that identifies legacy ROs for legacy UE. That is, the legacy ROs may include ROs that are configured and available for any UE, such as legacy UE that may not support certain triggering events. Other PRACH configurations may identify additional ROs that are available for the legacy UE (e.g., when supported) as well as advanced UE. The advanced UE in this context may refer to UEs that support PRACH transmissions using additional ROs for varying triggering events.

One example of a triggering event may include an initial access when the UE is operating in a radio resource control (RRC) idle state. This triggering event may be a contention-based PRACH transmission where the UE sends an RRCSetupRequest message to the network entity in a PRACH message three (Msg3) of a PRACH procedure. Another triggering event may include a UE transitioning from RRC inactive to RRC connected. This triggering event may be a contention-based PRACH transmission where the UE sends a RRCResumeRequest message to the network entity in the PRACH Msg3. Another triggering event may include a RRC connection reestablishment. This triggering event may be a contention-based PRACH transmission where the UE sends a RRCReestablishmentRequest message to the network entity in the PRACH Msg3.

Another triggering event may include a handover procedure. This triggering event may be a contention-based or a contention-free PRACH transmission where the network entity provides a preamble using a RACH-ConfigDedicated parameter in the RRCReconfiguration message and the UE sends a RRCReconfigurationComplete message in the PRACH Msg3. Another triggering event may include a downlink data arrival at the network entity while the UE is out of synchronization. This triggering event may be contention-based or a contention-free PRACH transmission where network entity signals a PDCCH-Order to the UE using a DCI format 1_0 with (contention-free) or without (contention-based) preamble index and the UE, for contention resolution, including a cell-specific radio network temporary identifier (C-RNTI) MAC-CE in the PRACH Msg3.

Another triggering event may include uplink data arrival at the UE while the UE is out of synchronization. This triggering event may be a contention-based PRACH transmission where the UE, for contention resolution, includes a C-RNTI MAC-CE in the PRACH Msg3. Another triggering event may include uplink data arrival at the UE without the UE having a PUSCH allocation. This triggering event may be a contention-based PRACH transmission where the UE, for contention resolution, includes the C-RNTI MAC-CE in the PRACH Msg3 and, in some cases, the Msg3 may include a buffer status report (BSR) MAC-CE to request additional uplink resources. Another triggering event may include an on-demand system information procedure. This triggering event may be a contention-based (Msg3-based) or a contention-free (message one (Msg1)-based) PRACH transmission. For the contention-based approach, the network entity may not include a SI-RequestConfig information element (IE) or parameter in the system information block one (SIB1) message while the UE may send a rrcSystemInfoRequest IE in the PRACH Msg3. For the contention-free approach, the network entity may include the si-RequestConfig IE or parameter in the SIB1 message while the UE may transmit a specific PRACH preamble in the PRACH Msg1 to request a specific system block (SB) and then monitors PDCCH for system information (SI) after the PRACH message two (Msg2).

Another triggering event may include a beam failure recovery (BFR) procedure. This triggering event may be a contention-based or a contention-free PRACH transmission. For the contention-based approach, the UE may select a PRACH preamble corresponding to the synchronization signal block (SSB) beam for recover. For the contention-free approach, the network entity may provide the UE with one PRACH preamble index for each beam available for recovery. Another triggering event may include a scheduling request (SR) failure. This triggering event may be a contention-based PRACH transmission where the UE uses Random Access if the network entity does not provide an uplink grant after sr-TransMax (4 to 64) SRs.

Another triggering event may include a synchronous reconfiguration. This triggering event may be a contention-based or a contention-free PRACH transmission where the network entity triggers synchronous reconfiguration by include a reconfigurationWithSync IE within the RRCReconfiguration message and the UE performs contention-based (ra-PreambleIndex excluded from reconfigurationWithSync) or contention-free (ra-PreambleIndex included in the reconfigurationWithSync) random access. Another triggering event may include establishing time alignment during SCell addition. This triggering event may be a contention-based or a contention-free PRACH transmission used to initialize the timing advance of a newly added SCell belonging to a new timing advance group (TAG). The contention-based or the contention-free may be based on whether the ra-PreambleIndex is excluded from the reconfigurationWithSync IE.

Moreover, each PRACH configuration may be associated with or otherwise have a feature combination preambles IE. The feature combination preamble IE may define various feature combinations applicable to the PRACH configuration, such as the start of the PRACH preamble, the number of preambles-per-SSB, an SSB shared RO mask index, group configurations, and other information.

In some aspects, the additional PRACH resources (e.g., the additional ROs) may be semi-statically configured (e.g., using RRC signaling or using MAC-CE signaling) while the availability indication (e.g., an activation signal) may be dynamically indicated (e.g., using MAC-CE signaling or using DCI signaling) to the UE. The additional PRACH resources may be configured for the common configuration or for dedicated configurations. For the dedicated configurations, there may be multiple PRACH configurations. However, some wireless networks may not define how the adaptation indication (e.g., the activation signal) may indicate the additional PRACH resources of a given PRACH configuration. One mechanism may be that the adaptation indication may indicate which PRACH configuration whose additional PRACH resources are adapted (e.g., activated). However, if the paging DCI is used for the adaptation indication this may not provide a mechanism for indicating which configuration because there is a limited availability of the number of bits that can be used for this purpose. In some aspects, each feature may have a different set of ROs since the featurecombinationpreambles IE may contain an SSB-RO mask index that may mask different subset of the ROs. Thus, within one PRACH configuration different sets of ROs could be defined for specific features and across different PRACH configurations there could be additional PRACH resources.

Accordingly, aspects of the techniques described herein provide various mechanisms to use the adaptation indication (e.g., the activation signal) to indicate adaptation (e.g., activation) of a set of feature combinations or a set of PRACH configurations. This may include the UE (e.g., the UE 205) being configured with additional PRACH configurations for multiple configurations. For example, at 215 the network entity 210 may transmit or otherwise output (and the UE 205 may receive or otherwise obtain) information identifying a set of PRACH configurations (e.g., multiple PRACH configurations). In some aspects, the set of PRACH configurations may include one or more PRACH configurations associated with the same triggering event or with different triggering events. Each PRACH configuration may identify or otherwise define additional PRACH resources (e.g., additional ROs) that are or may be available for PRACH transmissions. In some aspects, this may include the UE 205 being semi-statically configured with multiple PRACH resources (e.g., additional ROs).

In some aspects, each PRACH configuration may include or have a common configuration among the set of PRACH configurations. That is, if the UE 205 is semi-statically configured with multiple PRACH resources, the UE 205 may be configured with additional PRACH resource configuration that is common for all PRACH configurations. For example, this may include a common scaling factor (e.g., multiply or divide by 2 or 0.5) that applied for one or more of the parameters within the PRACH configuration. For example, this may include a first PRACH configuration (config1) having a periodicity of x1 and a second PRACH configuration (config2) having a second periodicity of x2. In this example where each PRACH configuration includes a common configuration, the scaling parameter may include multiplying each periodicity by 0.5 to obtain the periodicity of the PRACH ROs for each PRACH configuration. For example, the periodicity of the ROs defined by config1 may be x1*0.5 while the periodicity of the ROs defined by config 2 may be x2*0.5. Thus, in this example the additional resources may be identified or otherwise determined by updating the value y (e.g., a parameter) for the corresponding configuration.

In other aspects, each PRACH configuration may include or have different configurations among the set of PRACH configurations. That is, if the UE 205 is semi-statically configured with multiple PRACH resources, the UE 205 may be configured with additional PRACH resource configuration that is separate for each configuration. Thus, in this example the different configurations may correspond to different scaling factors being applied to parameter(s) of each PRACH configuration in the set of PRACH configurations. Using the example above, the periodicity of the ROs defined by config1 may be x1*2 while the periodicity of the ROs defined by config2 may be defined by x2*4 (e.g., the periodicity of each PRACH configuration is scaled differently).

In some aspects, the PRACH configurations in the set of PRACH configurations may include a same feature combination configuration (e.g., IE) as the legacy PRACH configuration (e.g., the PRACH configuration for legacy ROs) that is different from the set of PRACH configurations. That is, the additional PRACH resources may have the same featurecombination IE as in the underlying legacy configuration. In other aspects, the PRACH configurations in the set of PRACH configurations may include a different feature combination configuration (e.g., IE) as the legacy PRACH configuration that is different from the set of PRACH configurations. That is, the additional PRACH resources may have separate featurecombination IE from the underlying legacy configuration.

At 220, the network entity 210 may transmit or otherwise output (and the UE 205 may receive or otherwise obtain) an activation signal (e.g., an adaptation indication). The activation signal may active one or more of the PRACH configurations in the set of PRACH configurations. When the additional PRACH resources are configured for multiple PRACH resources (e.g., whether jointly or separately), the adaptation indication may be configured to activate one or more of the PRACH configurations.

One approach may include a single adaptation indication for all configured additional PRACH resources being used. That is, the activation signal in this example may activate each PRACH configuration in the set of PRACH configurations. For example, if the UE 205 receives an availability indication (e.g., the activation signal), the UE 205 may assume the availability of all additional PRACH resources across all PRACH configurations.

Another approach may include the adaptation indication indicating which additional PRACH configuration is going to be available. That is, the activation signal may include, carry, or otherwise convey an indication of which PRACH configuration(s) in the set of PRACH configurations is(are) activated. For example, the activation signal may include a bitmap where each bit corresponds to a corresponding PRACH configuration. The bit being set to “1” may indicate that this PRACH configuration is activated while the bit being set to “0” may indicate that that this PRACH configuration is not activated, or vice versa. Other examples may include one or more bits being set to a value that corresponds to a table entry where the corresponding table entry defines which PRACH configurations are activated.

Another approach may be that the additional PRACH configurations are grouped into sets (e.g., subsets) and the availability indication (e.g., the activation signal) indicates the availability of specific set(s). That is, the set of PRACH configurations may include one or more subsets of PRACH configuration and the activation signal may identify which subset(s) of PRACH configurations in the set of PRACH configurations are activated. In some aspects, the different subsets may correspond to or otherwise be based on an operating mode of the UE 205. For example, the network entity 210 may indicate the availability of all additional PRACH resources available to idle/inactive mode UEs (e.g., UEs operating in RRC idle or RRC inactive may correspond to a subset of PRACH configurations) but not the dedicated configuration, and vice versa.

In some aspects, the activation signal may include an indication of a feature combination activation state for the one or more PRACH configurations being activated. That is, the adaptation indication may indicate an availability of all feature combinations, of select feature combinations (e.g., a subset of feature combinations), or a subset of all feature combinations (e.g., individual ones of the feature combinations) corresponding to the feature combination IE.

In some aspects, the information identifying the set of PRACH configurations may be received in the activation signal. For example, the network entity 210 may transmit (and the UE 205 may receive) the activation signal at 220 that both identifies the set of PRACH configurations for the UE 205 as well as indicates that one or more of the PRACH configurations are activated. In this example, the information identifying the set of PRACH configurations may be indicated in a MAC-CE, such as in a DCI MAC-CE parameter.

In some aspects, the information identifying the set of PRACH configurations may be received in a signal that is different from the activation signal. For example, the information identifying the set of PRACH configurations may be received in a RRC signal while the activation signal may be a DCI signal.

At 225, the UE 205 may perform PRACH transmission(s) using the additional PRACH resources corresponding to the PRACH configuration(s) that are activated. For example, the UE 205 may transmit or otherwise output (and the network entity 210 may receive or otherwise obtain) one or more PRACH transmissions using the additional ROs corresponding to the activated PRACH configuration(s).

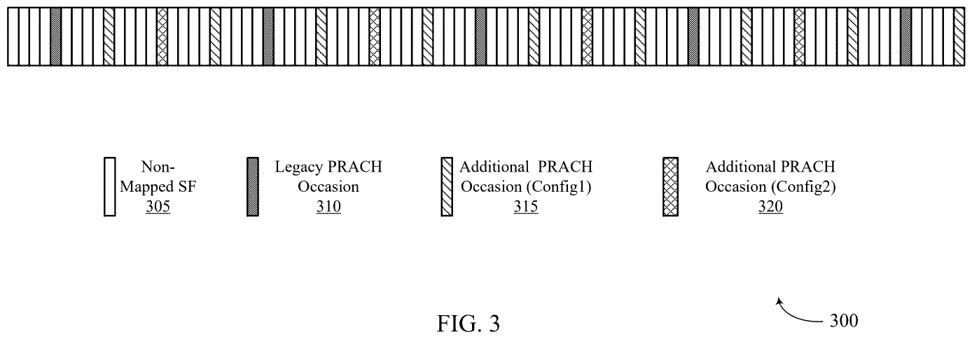

FIG. 3 shows an example of a PRACH scheme 300 that supports configuration and adaptation of additional PRACH resources in accordance with one or more aspects of the present disclosure. PRACH scheme 300 may implement aspects of or be implemented by aspects of wireless communications system 100 or wireless communications system 200. Aspects of PRACH scheme 300 may be implemented at or implemented by a UE or a network entity, which may be examples of the corresponding devices described herein.

As discussed above, aspects of the techniques described herein provide for configuration of additional PRACH configurations for multiple configurations for a UE. For example, the UE may receive information identifying a set of PRACH configurations from a network entity. Each PRACH configuration in the set of PRACH configurations may generally allocate, identify, or otherwise define additional PRACH resources that are available for PRACH transmissions (e.g., once activated). The UE may receive an activation signal that activates one or more PRACH configurations in the set of PRACH configurations and perform the PRACH transmissions using the additional PRACH resources corresponding to the activated PRACH configuration(s).

For example, PRACH scheme 300 illustrates an example where the set of PRACH configurations includes two PRACH configurations (although there may be more than two PRACH configurations in the set of PRACH configurations). Generally, the PRACH scheme 300 is shown on the subframe (SF) basis that includes a number of non-mapped SFs 305 (e.g., subframes where no PRACH resources are configured). The PRACH scheme 300 also include legacy PRACH occasions 310 (e.g., subframes where legacy ROs are configured and available for use, in some cases). The PRACH scheme 300 also includes a first PRACH configuration (e.g., additional PRACH occasions 315) that is identified by config1 and a second PRACH configuration (e.g., additional PRACH occasions 320) that is identified by config2. The activation signal may activate config1, config2, or both PRACH configurations. The UE may perform the PRACH transmissions using the additional PRACH occasions 315, using the additional PRACH occasions 320, or using both additional PRACH configurations based on which PRACH configuration is activated.

In this example, the periodicity of the second PRACH configuration is half the periodicity of the first PRACH configuration. That is, for every legacy RO there are two additional ROs from the first PRACH configuration and one additional RO from the second PRACH configuration. In some aspects, this may be based on whether the additional PRACH resource configurations is common for all PRACH configurations or separate for each PRACH configuration.

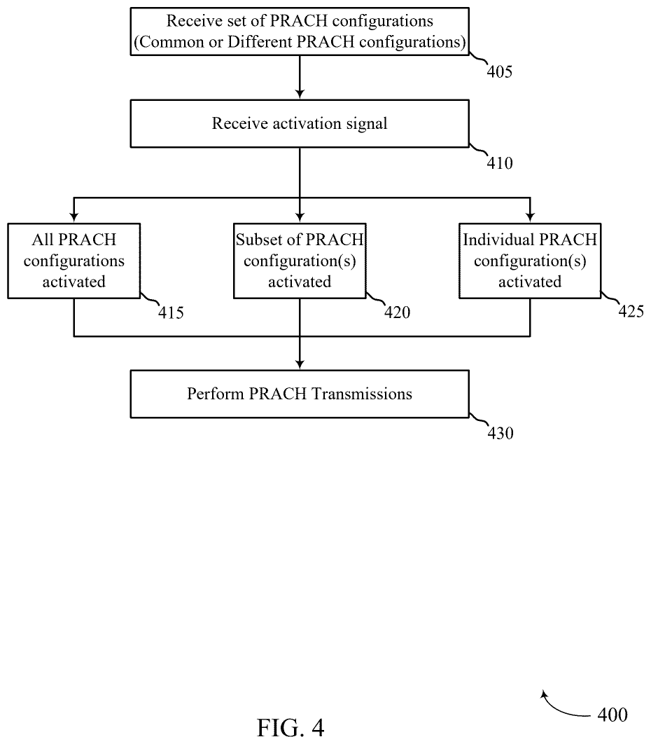

FIG. 4 shows an example of a method 400 that supports configuration and adaptation of additional PRACH resources in accordance with one or more aspects of the present disclosure. Method 400 may implement aspects of or be implemented by aspects of wireless communications system 100 or wireless communications system 200 or aspects of PRACH scheme 300. Aspects of method 400 may be implemented at or implemented by a UE or a network entity, which may be examples of the corresponding devices described herein.

As discussed above, aspects of the techniques described herein provide for configuration of additional PRACH configurations for multiple configurations for a UE. For example, at 405 the UE may receive information identifying a set of PRACH configurations from a network entity. Each PRACH configuration in the set of PRACH configurations may generally allocate, identify, or otherwise define additional PRACH resources that are available for PRACH transmissions (e.g., once activated). The PRACH configurations in the set of PRACH configurations may be include either common additional PRACH resource configurations for all PRACH configurations in the set or separate for each PRACH configuration.

At 410, the UE may receive an activation signal that activates one or more PRACH configurations in the set of PRACH configurations. In some aspects, when the additional PRACH resources are configured for multiple PRACH resources (whether jointly or separately), the adaptation indication (e.g., the activation signal) may take various forms. One form is shown at 415 where the activation signal activates each (e.g., all) PRACH configuration in the set of PRACH configurations. Thus, in this example a single adaptation indication may be provided for all configured additional PRACH resources. For example, if the UE receives an availability indication (e.g., the activation signal), the UE may assume the availability of all additional PRACH resources across all PRACH configurations. That is, the UE may assume that all PRACH configurations in the set of PRACH configurations are activated.

Another form is shown at 420 where the activation signal includes an indication of which PRACH configuration(s) in the set of PRACH configurations are activated. That is, in this example the adaptation indication may indicate which additional PRACH configuration(s) is or are going to be available for PRACH transmissions. Another form is shown at 425 where the set of PRACH configurations include subset(s) of PRACH configurations and the activation signal identifies which subset(s) of PRACH configurations are activated. That is, the additional PRACH configurations may be grouped into sets (e.g. subsets) and the availability indication may indicate the availability of a specific set (e.g., subset(s)).

At 430, the UE may perform the PRACH transmissions using the additional PRACH resources corresponding to the activated PRACH configuration(s). For example, the UE may perform PRACH transmissions using the additional ROs corresponding to the activated PRACH configurations identified by the activation signal.

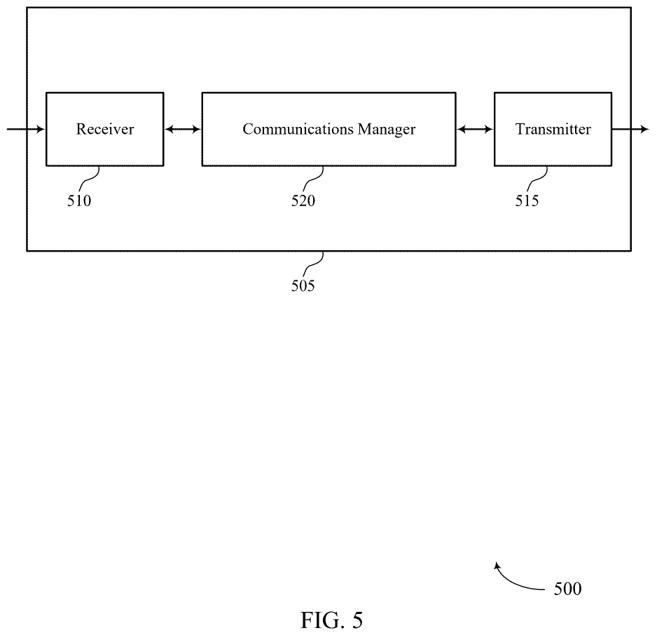

FIG. 5 shows a block diagram 500 of a device 505 that supports configuration and adaptation of additional PRACH resources in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses). The device 505 may include one or more processors, memory coupled with the one or more processors, and instructions stored in the memory that are executable by the one or more processors to enable the one or more processors to perform the configuration and adaptation of additional PRACH resources features discussed herein.

The receiver 510 may provide a means for receiving information such as packets, user data, control information, or any combination thereof associated with various information channels (e.g., control channels, data channels, information channels related to configuration and adaptation of additional PRACH resources). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configuration and adaptation of additional PRACH resources). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of configuration and adaptation of additional PRACH resources as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving information identifying a set of PRACH configurations, each PRACH configuration in the set of PRACH configurations identifying additional PRACH resources available for PRACH transmissions. The communications manager 520 is capable of, configured to, or operable to support a means for receiving an activation signal that activates one or more PRACH configurations in the set of PRACH configurations. The communications manager 520 is capable of, configured to, or operable to support a means for performing one or more PRACH transmissions using the additional PRACH resources corresponding to the one or more PRACH configurations that are activated.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for using the adaptation indication (e.g., an activation signal) to indicate the adaptation (e.g., activation) of a set of feature combinations or a set of PRACH configurations.

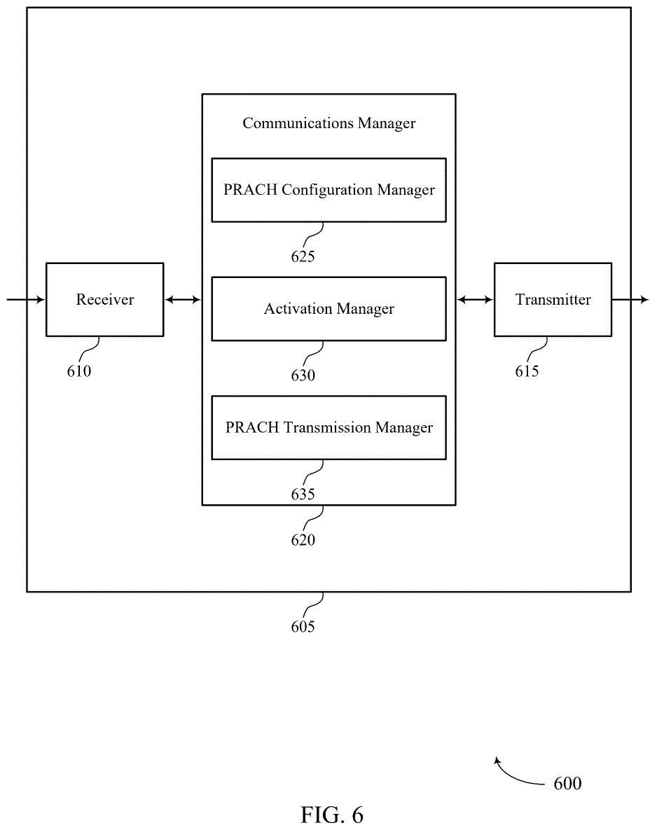

FIG. 6 shows a block diagram 600 of a device 605 that supports configuration and adaptation of additional PRACH resources in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to configuration and adaptation of additional PRACH resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuration and adaptation of additional PRACH resources). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of configuration and adaptation of additional PRACH resources as described herein. For example, the communications manager 620 may include a PRACH configuration manager 625, an activation manager 630, a PRACH transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The PRACH configuration manager 625 is capable of, configured to, or operable to support a means for receiving information identifying a set of PRACH configurations, each PRACH configuration in the set of PRACH configurations identifying additional PRACH resources available for PRACH transmissions. The activation manager 630 is capable of, configured to, or operable to support a means for receiving an activation signal that activates one or more PRACH configurations in the set of PRACH configurations. The PRACH transmission manager 635 is capable of, configured to, or operable to support a means for performing one or more PRACH transmissions using the additional PRACH resources corresponding to the one or more PRACH configurations that are activated.

In some examples, PRACH configurations include a common configuration among the set of PRACH configurations. In some examples, the common configuration corresponds to a common scaling factor being applied to one or more parameters of each PRACH configuration in the set of PRACH configurations.

In some examples, the different configurations corresponds to different scaling factors being applied to one or more parameters of each PRACH configuration in the set of PRACH configurations. In some examples, PRACH configurations include different configurations among the set of PRACH configurations. In some examples, PRACH configurations in the set of PRACH configurations include a same feature combination configuration as a legacy PRACH configuration that is different from the set of PRACH configurations. In some examples, PRACH configurations in the set of PRACH configurations include a different feature combination configuration as a legacy PRACH configuration that is different from the set of PRACH configurations.

In some examples, the activation signal activates each PRACH configuration in the set of PRACH configurations. In some examples, the activation signal includes an indication of which PRACH configurations in the set of PRACH configurations are activated. In some examples, the set of PRACH configurations includes one or more subsets of PRACH configurations and the activation signal identifies which subsets of PRACH configurations in the set of PRACH configurations are activated.

In some examples, different subsets of the one or more subsets of PRACH configurations correspond to an operating mode of the UE. In some examples, the activation signal includes an indication of a feature combination activation state for the one or more PRACH configurations. In some examples, the feature combination activation state corresponds to all feature combinations, a subset of feature combinations, or individual feature combinations in the set of PRACH configurations. In some examples, the information identifying the set of PRACH configurations is received in the activation signal. In some examples, the information identifying the set of PRACH configurations is received in a signal that is different from the activation signal.

The communications manager 620, the PRACH configuration manager 625, the activation manager 630, and the PRACH transmission manager 635 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the PRACH configuration manager 625, the activation manager 630, and the PRACH transmission manager 635 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

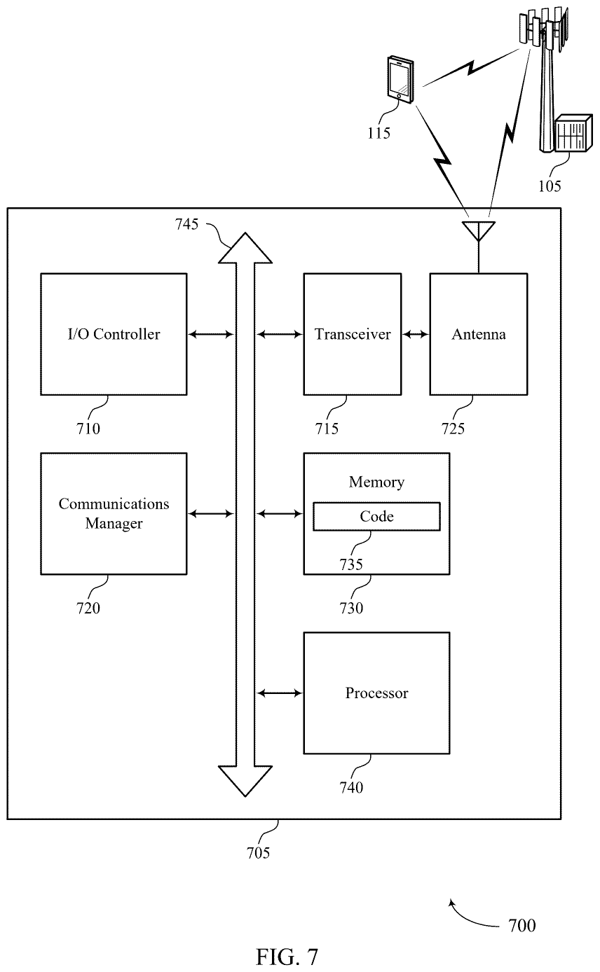

FIG. 7 shows a diagram of a system 700 including a device 705 that supports configuration and adaptation of additional PRACH resources in accordance with one or more aspects of the present disclosure. The device 705 may be an example of or include components of a device 505, a device 605, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 515, a transmitter 615, a receiver 510, a receiver 610, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting configuration and adaptation of additional PRACH resources). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving information identifying a set of PRACH configurations, each PRACH configuration in the set of PRACH configurations identifying additional PRACH resources available for PRACH transmissions. The communications manager 720 is capable of, configured to, or operable to support a means for receiving an activation signal that activates one or more PRACH configurations in the set of PRACH configurations. The communications manager 720 is capable of, configured to, or operable to support a means for performing one or more PRACH transmissions using the additional PRACH resources corresponding to the one or more PRACH configurations that are activated.

By including or configuring the communications manager 720 in accordance with examples as described herein, the device 705 may support techniques for using the adaptation indication (e.g., an activation signal) to indicate the adaptation (e.g., activation) of a set of feature combinations or a set of PRACH configurations.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of configuration and adaptation of additional PRACH resources as described herein, or the at least one processor 740 and the at least one memory 730 may be otherwise configured to, individually or collectively, perform or support such operations.

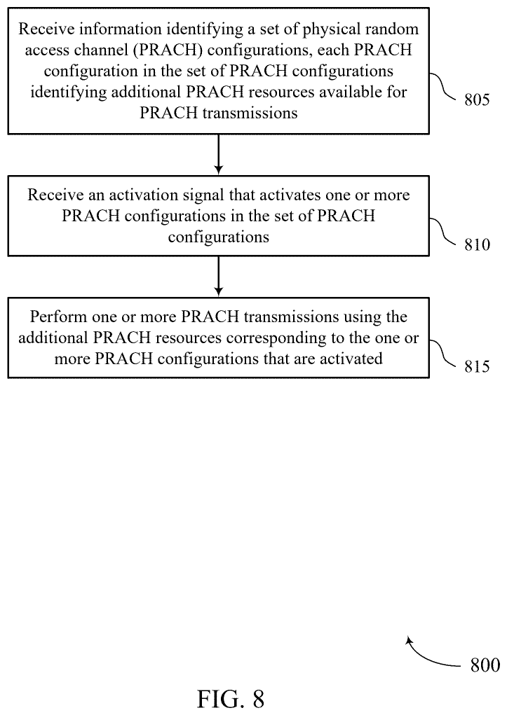

FIG. 8 shows a flowchart illustrating a method 800 that supports configuration and adaptation of additional PRACH resources in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving information identifying a set of PRACH configurations, each PRACH configuration in the set of PRACH configurations identifying additional PRACH resources available for PRACH transmissions. The operations of 805 may be performed in accordance with examples as disclosed herein.

At 810, the method may include receiving an activation signal that activates one or more PRACH configurations in the set of PRACH configurations. The operations of 810 may be performed in accordance with examples as disclosed herein.

At 815, the method may include performing one or more PRACH transmissions using the additional PRACH resources corresponding to the one or more PRACH configurations that are activated. The operations of 815 may be performed in accordance with examples as disclosed herein.

The following provides an overview of aspects of the present disclosure:

Aspect 1: A method for wireless communications at a UE, comprising: receiving information identifying a set of PRACH configurations, each PRACH configuration in the set of PRACH configurations identifying additional PRACH resources available for PRACH transmissions; receiving an activation signal that activates one or more PRACH configurations in the set of PRACH configurations; and performing one or more PRACH transmissions using the additional PRACH resources corresponding to the one or more PRACH configurations that are activated.

Aspect 2: The method of aspect 1, wherein PRACH configurations comprise a common configuration among the set of PRACH configurations.

Aspect 3: The method of aspect 2, wherein the common configuration corresponds to a common scaling factor being applied to one or more parameters of each PRACH configuration in the set of PRACH configurations.

Aspect 4: The method of any of aspects 2 through 3, wherein the different configurations corresponds to different scaling factors being applied to one or more parameters of each PRACH configuration in the set of PRACH configurations.

Aspect 5: The method of any of aspects 1 through 4, wherein PRACH configurations comprise different configurations among the set of PRACH configurations.

Aspect 6: The method of any of aspects 1 through 5, wherein PRACH configurations in the set of PRACH configurations comprise a same feature combination configuration as a legacy PRACH configuration that is different from the set of PRACH configurations.

Aspect 7: The method of any of aspects 1 through 6, wherein PRACH configurations in the set of PRACH configurations comprise a different feature combination configuration as a legacy PRACH configuration that is different from the set of PRACH configurations.

Aspect 8: The method of any of aspects 1 through 7, wherein the activation signal activates each PRACH configuration in the set of PRACH configurations.

Aspect 9: The method of any of aspects 1 through 8, wherein the activation signal includes an indication of which PRACH configurations in the set of PRACH configurations are activated.

Aspect 10: The method of any of aspects 1 through 9, wherein the set of PRACH configurations includes one or more subsets of PRACH configurations and the activation signal identifies which subsets of PRACH configurations in the set of PRACH configurations are activated.

Aspect 11: The method of aspect 10, wherein different subsets of the one or more subsets of PRACH configurations correspond to an operating mode of the UE.

Aspect 12: The method of any of aspects 1 through 11, wherein the activation signal includes an indication of a feature combination activation state for the one or more PRACH configurations.

Aspect 13: The method of aspect 12, wherein the feature combination activation state corresponds to all feature combinations, a subset of feature combinations, or individual feature combinations in the set of PRACH configurations.

Aspect 14: The method of any of aspects 1 through 13, wherein the information identifying the set of PRACH configurations is received in the activation signal.

Aspect 15: The method of any of aspects 1 through 14, wherein the information identifying the set of PRACH configurations is received in a signal that is different from the activation signal.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively configured to cause the UE to:
receive information identifying a set of physical random access channel (PRACH) configurations, each PRACH configuration in the set of PRACH configurations identifying additional PRACH resources available for PRACH transmissions;
receive an activation signal that activates one or more PRACH configurations in the set of PRACH configurations; and
perform one or more PRACH transmissions using the additional PRACH resources corresponding to the one or more PRACH configurations that are activated.

2. The UE of claim 1, wherein PRACH configurations comprise a common configuration among the set of PRACH configurations.

3. The UE of claim 2, wherein the common configuration corresponds to a common scaling factor being applied to one or more parameters of each PRACH configuration in the set of PRACH configurations.

4. The UE of claim 2, wherein the different configurations corresponds to different scaling factors being applied to one or more parameters of each PRACH configuration in the set of PRACH configurations.

5. The UE of claim 1, wherein PRACH configurations comprise different configurations among the set of PRACH configurations.

6. The UE of claim 1, wherein PRACH configurations in the set of PRACH configurations comprise a same feature combination configuration as a legacy PRACH configuration that is different from the set of PRACH configurations.

7. The UE of claim 1, wherein PRACH configurations in the set of PRACH configurations comprise a different feature combination configuration as a legacy PRACH configuration that is different from the set of PRACH configurations.

8. The UE of claim 1, wherein the activation signal activates each PRACH configuration in the set of PRACH configurations.

9. The UE of claim 1, wherein the activation signal includes an indication of which PRACH configurations in the set of PRACH configurations are activated.

10. The UE of claim 1, wherein the set of PRACH configurations includes one or more subsets of PRACH configurations and the activation signal identifies which subsets of PRACH configurations in the set of PRACH configurations are activated.

11. The UE of claim 10, wherein different subsets of the one or more subsets of PRACH configurations correspond to an operating mode of the UE.

12. The UE of claim 1, wherein the activation signal includes an indication of a feature combination activation state for the one or more PRACH configurations.

13. The UE of claim 12, wherein the feature combination activation state corresponds to all feature combinations, a subset of feature combinations, or individual feature combinations in the set of PRACH configurations.

14. The UE of claim 1, wherein the information identifying the set of PRACH configurations is received in the activation signal.

15. The UE of claim 1, wherein the information identifying the set of PRACH configurations is received in a signal that is different from the activation signal.

16. A method for wireless communications at a user equipment (UE), comprising:
receiving information identifying a set of physical random access channel (PRACH) configurations, each PRACH configuration in the set of PRACH configurations identifying additional PRACH resources available for PRACH transmissions;
receiving an activation signal that activates one or more PRACH configurations in the set of PRACH configurations; and
performing one or more PRACH transmissions using the additional PRACH resources corresponding to the one or more PRACH configurations that are activated.

17. The method of claim 16, wherein PRACH configurations comprise a common configuration among the set of PRACH configurations.

18. The method of claim 17, wherein the common configuration corresponds to a common scaling factor being applied to one or more parameters of each PRACH configuration in the set of PRACH configurations.

19. The method of claim 17, wherein the different configurations corresponds to different scaling factors being applied to one or more parameters of each PRACH configuration in the set of PRACH configurations.

20. A non-transitory computer-readable medium storing code for wireless communications, the code comprising instructions executable by one or more processors to:
receive information identifying a set of physical random access channel (PRACH) configurations, each PRACH configuration in the set of PRACH configurations identifying additional PRACH resources available for PRACH transmissions;
receive an activation signal that activates one or more PRACH configurations in the set of PRACH configurations; and
perform one or more PRACH transmissions using the additional PRACH resources corresponding to the one or more PRACH configurations that are activated.
